(19) United States
(12) Patent Application Publication
(10) Pub. No.: US 2017/0159326 A1
(43) Pub. Date: Jun. 8, 2017

(54) DOOR JAMB REINFORCEMENT SYSTEM AND METHOD

(71) Applicant: Robert W Piston, Hermitage, PA (US)

(72) Inventor: Robert W Piston, Hermitage, PA (US)

(21) Appl. No.: 15/369,866

(22) Filed: Dec. 5, 2016

Related U.S. Application Data
(60) Provisional application No. 62/263,727, filed on Dec. 6, 2015.

(51) Int. Cl. E05B 17/20; E05B 15/02

(52) U.S. Cl. CPC E05B 17/2084; E05B 15/0205

(57) ABSTRACT

The present disclosure relates to an improved system and method for reinforcing a door jamb so as to decrease the risk of a break-in through a door. In particular, the present disclosure describes at least two reinforcement plates that are positioned within the door jamb and a wall adjacent to the door. One reinforcement plate is positioned within the door jamb such that a latch of a doorknob and, optionally, a latch of a deadbolt, may be secured therein when the door is closed. A second reinforcement plate is positioned within the wall and disposed perpendicularly to the first reinforcement plate such that the second plate provides a reaction force against the first plate when an impact force is applied to the door. The present disclosure also describes various novel methods for reinforcing a door jamb.

### FIELD OF THE INVENTION

The present disclosure relates to an improved system and method for reinforcing a door jamb so as to decrease the risk of a break-in through a door. In particular, the present disclosure describes at least two reinforcement plates that are positioned within the door jamb and a wall adjacent to the door. One reinforcement plate is positioned within the door jamb such that a latch of a doorknob and, optionally, a latch of a deadbolt, may be secured therein when the door is closed. A second reinforcement plate may be positioned within the wall perpendicularly to and overlapping the first reinforcement plate such that the second reinforcement plate provides a reaction force against the first plate when an impact force is applied to a closed door. The present disclosure also describes a system for reinforcing door hinges within a door jamb in addition to various novel methods for reinforcing a door jamb.

### BACKGROUND

Doors have long been used to control access to enclosed spaces, such as, for example, in residential buildings, commercial buildings, places of worship, etc. Traditional doors are mounted in a door frame via hinges that allow the door to swing about the door frame between an open state and a closed state. These doors generally include cut-outs in which an owner may install a doorknob and, optionally, additional locking mechanisms such as deadbolts. The door knob is used to control whether a door is able to be opened. In particular, the door knob may be rotatable such that it controls the extension of a latch from the door into a corresponding cut-out in a vertical wooden beam of a door frame, also called a door jamb. When the door is flush with the door jamb and the latch extends into the door jamb, the door is prevented from swinging open and is in its closed state. The door knob may further be locked from rotating so that the door cannot be opened from its closed state. When the door knob is rotated, the latch is retracted from the cut-out in the door jamb and the door is moveable about its hinged to its open state.

Door frames (and door jambs) for residential homes are generally made of wood while latches and deadbolts are made from metal. Metal is harder than wood, and as such, a sudden impact force near the latch may cause the latch to shear through the wooden door jamb, thus compromising security. For example, a burglar may attempt forcible entry into (i.e., “break into”) a home by kicking or otherwise impacting a door near its door knob to cause the latch to shear through the wooden door jamb. Forcible entry and attempted forcible entry occur in a majority of burglaries. According to the FBI's Uniform Crime Reporting Program, burglaries accounted for 23.8% of the estimated number of property crimes committed in 2010 in the United States. Of all burglaries, 60.5% accounted for forcible entry and 6.3% were forcible entry attempts. In addition, the economic value lost by victims of burglary is significant. In particular, victims of burglary offenses suffered an estimated $4.6 billion in lost property in 2010 with the average dollar loss per burglary offense estimated at $2,119.

Wooden door jambs may include a single, small metal plate, also called a strike plate, that serves to prevent the metal latch of the door knob from shearing through the wooden door frame. However, strike plates are generally made from thin sheets of metal and do not effectively prevent an attempted break-in. Strike plates are secured to wooden frames with metal screws, and the metal screws may shear through the wooden frame if a large impact force is applied to the door. Prior art strike plates generally include a single, metal strike plate that is fixed to a surface of the door jamb facing the door and serve as a thicker or longer strike plate. These prior art strike plates suffer from similar issues as their thinner strike plate counterparts where a shearing force from the thicker/longer strike plate can still compromise the security of the door. They also suffer from cosmetic problems because they are visible when a person opens a door.

Due to the potential for economic loss due to a burglary offense, a market need exists for improving the security of buildings and, in more particularly, improving the security of access points into those buildings. Accordingly, a need therefore exists for a door jamb reinforcement system that can resist large shear forces to significantly increase the amount of force required to compromise a door and reduce the risk of forcible entry.

### SUMMARY OF THE INVENTION

The present disclosure provides for a door jamb reinforcement device for reducing the risk of an attempted break-in on a door and thus improving security. The door jamb reinforcement system includes a first plate comprising a through-hole configured to receive a latch of a door knob. The first plate may further include additional through-holes of a similar or different (i.e., larger or smaller) size compared to the through-hole that receives the latch. The first plate may be configured to be affixed to a door jamb via one or more fixation mechanisms such as, for example, screws, bolts, nails, and/or adhesive. If an adhesive is used to affix the first plate to the door jamb, contacting surfaces of the door jamb and/or first plate may be roughened using a roughening process as is known in the art such as, for example, sanding or sandblasting to improve adhesion. The fixation mechanisms may be placed into the through-holes of the first plate such that they extend into the door jamb to secure the first plate to the door jamb.

The door jamb reinforcement system further includes a second plate disposed perpendicularly to the first plate and in contact with the first plate. The second plate may be affixed to a stud in a wall via fixation mechanisms and through-holes similar to those described above and in more detail below. The second plate may also be affixed to the first plate via fixation mechanisms and through-holes similar to those described above and in more detail below. An end section of the second plate substantially overlaps a side surface of the first plate. In an embodiment, the end section of the second plate may overlap the entire side of the first plate, or only partially overlap the side of the first plate.

In an implementation, the first plate comprises a metal or metal alloy. The metal of the first plate may be stainless steel, carbon steel, alloy steel, titanium, or brass. In an implementation, the second plate comprises a metal or metal alloy. The metal of the second plate may be stainless steel, carbon steel, alloy steel, titanium, or brass. One of skill in the art will recognize that any suitable material may be used to fabricate the first and second plates including, for example, composites, plastics, wood, and/or other metals and metal alloys.

The present disclosure further provides for a door jamb reinforcement system for reducing the risk of an attempted break-in on a door and thus improving security. The door jamb reinforcement system includes a door jamb comprising a door frame having a door jamb. The door jamb reinforcement system may further include a door, a doorknob having a doorknob latch, and/or a deadbolt having a deadbolt latch. The door jamb reinforcement system further includes a first plate comprising a through-hole configured to receive a latch of a door knob. The first plate may be affixed to a surface of the door jamb. The door jamb reinforcement system further includes a second plate perpendicularly disposed to the first plate. A portion of the second plate may be in contact with the first plate. The second plate may be configured to be affixed to a stud in a wall, to the first plate, and/ or to the door jamb.

The present disclosure further provides for a method for reinforcing a door jamb. The method includes the step of affixing a first plate to a surface of a door jamb. The first plate may include a side surface configured to contact an end section of the second plate. The first plate may also include a through-hole configured to receive a latch of a door knob. The method further includes the step of affixing the second plate to a surface of a wall adjacent to the door jamb. A portion of the end section of the second plate may be perpendicular to and overlapping (partially or in total) with the side surface of the first plate. These steps may be performed in any order to reinforce a door jamb and improve security against an attempted break-in.

In an implementation, the second plate is positioned such that a portion of the end section is in contact with the side surface of the first plate to provide a reaction force against a latch of a door.

### BRIEF DESCRIPTION OF THE DRAWINGS

The foregoing and other objects and advantages will be apparent upon consideration of the following detailed description, taken in conjunction with the accompanying drawings, in which:

FIG. 1 shows a door jamb reinforcement plate.

FIG. 2 shows a door jamb reinforcement plate installed on a door jamb.

FIG. 3 shows a door jamb reinforcement system including a first door jamb reinforcement plate and a second door jamb reinforcement plate installed perpendicularly to one another.

FIG. 4 shows a door jamb reinforcement plate installed on a door jamb.

FIG. 5 shows a flow diagram for a method of installing a door jamb reinforcement.

### DETAILED DESCRIPTION

To provide an overall understanding of the systems, devices, and methods described herein, certain illustrative embodiments will be described. For the purpose of clarity and illustration, these systems, devices, and methods will be described with respect to door jamb reinforcement systems. It will be understood by one of ordinary skill in the art that such systems, devices, and methods described herein may be adapted and modified as appropriate, and that these systems, devices, and methods may be employed in other suitable applications, such as for other types of door reinforcements, and that such additions and/or modifications will not depart from the scope of the invention and claims hereof.

A door jamb reinforcement system of the present invention includes at least two plates positioned perpendicularly to one another to provide increased resistance against an impact force on a closed door, such as a force that would occur during an attempted break-in. A first plate may be positioned on an outer surface of a door jamb, such as, for example, the surface of the door jamb that is adjacent to the wall in which the door frame is mounted. In an embodiment, the door jamb may comprise, for example, one or more 2×4 wood blocks and/or one or more 2×6 wood blocks assembled together to form a door frame. After consideration of this disclosure, one of skill in the art will recognize that any suitably sized wooden block may be used and that the door frame may be manufactured of any suitable material, such as a plastic, metal, or combination of materials, for example. Preferably, the first plate is positioned on the outer surface of the door jamb so that it may be hidden from view when the door frame is installed in a doorway. However, in another embodiment, the first plate may be positioned on an inner surface of the door jamb, such as, for example, the surface of the door jamb that is adjacent to the door when the door is in the closed state.

The first plate may include one or more through-holes into which a fixation mechanism, such as screws, rivets, bolts, and/or nails, may be inserted (or threaded therethrough if threads are present on the fixation mechanism) to fix the first plate to the door jamb. The through-holes may be shaped appropriately (e.g., a circular or slot shape) such that the fixation mechanism may be inserted therethrough. In another embodiment, an adhesive may be used to affix the first plate to the door jamb. After consideration of this disclosure, one of skill in the art will recognize that any suitable fixation mechanism may be used to couple the first plate to the door jamb. In an alternative embodiment, the door jamb reinforcement system may include two or more plates affixed to a surface of the door jamb, where each plate corresponds to a latch of a doorknob or a latch of a deadbolt (i.e., each plate receives a single latch).

The second plate may be positioned substantially perpendicularly to the first plate such that the second plate provides a reaction force against the first plate when an impact force is applied to a closed door. In an embodiment, the second plate may be positioned on an inner surface of a wall that is adjacent to the door frame such that the second plate is in contact with (or substantially close to) the first plate. In another embodiment, the second plate may be positioned on an outer surface of the wall. In this embodiment, it may be necessary to extend a dimension of the first plate such that the first plate and second plate are in perpendicular contact with (or substantially close to) one another. The second plate is preferably contacting the first plate but may be within 10 millimeters of the first plate. Preferably, the second plate is positioned on the inner surface of the wall so that it may be easily hidden from view. The second plate may be positioned relative to the first plate such that an end section of the second plate is flush (and in partial or total contact) with a side of the first plate. This end section of the second plate may overlap a side of the first plate partially or in its entirety such that the end section of the second plate may provide a reaction force to the first plate when an impact force is applied to a closed door.

The second plate may include one or more through holes in which fixation mechanisms, such as screws, rivets, bolts, and/or nails, for example, may be inserted (or threaded therethrough if threads are present on the fixation mechanism) to fix the second plate to the wall. In another embodiment, the second plate may be coupled to the wall with an adhesive, similarly to that described above. In one embodiment, the second plate may be affixed to a stud in the wall to provide support against forces exerted from the side of the first plate to the end section of the second plate. In an embodiment, the stud may comprise, for example, one or more 2×4 wood blocks and/or one or more 2×6 wood blocks. However, one of skill in the art will understand from the foregoing that any size of wooden block may be used to form the door frame and/or the stud. Optionally, the stud may be made of a metal, plastic, or combination of materials. In another embodiment, the second plate may include one or more through-holes in which fixation mechanisms as described above may be inserted (or threaded therethrough) to fix the second plate to the first plate. In this embodiment, the first plate will also include bores in a side such that the fixation mechanism may affix the first plate to the second plate.

The door jamb reinforcement plates may be manufactured from a metal, metal alloy, plastic, composite, or any other suitable material. In an example, the door jamb reinforcement plates may be manufactured from a stainless steel, carbon steel, alloy steel, titanium, or brass. The first plate and the second plate may have dimensions that are suitable for installing in a wall and or a door jamb. For example, the first plate and the second plate may have a length of about 1 inch to about 10 inches. In another example, the first plate and the second plate may have a width of about 1 inch to about 10 inches. In yet another example, the first plate and the second plate may have a thickness of about 1/32 inch to about 2 inches. One of skill in the art will recognize that these dimensions may be modified to be larger or smaller depending on the size of the door jamb and the door being reinforced.

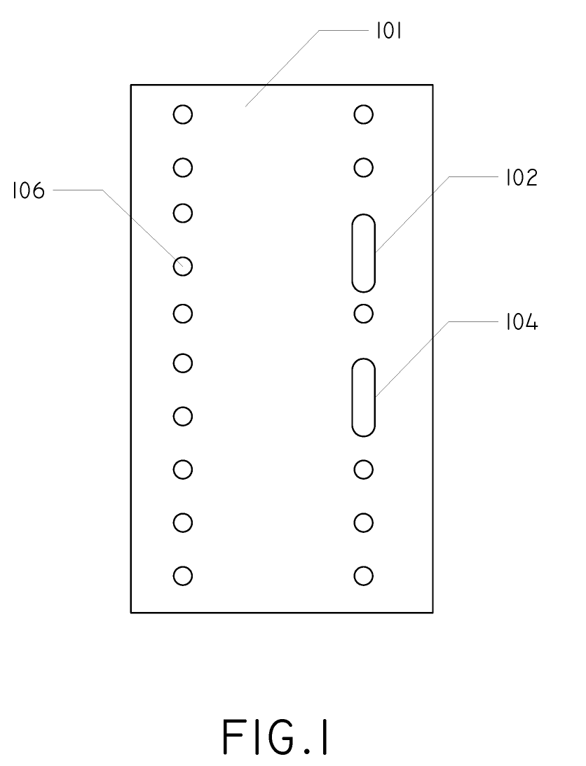

FIG. 1 shows a door jamb reinforcement plate 101. The door jamb reinforcement plate 101 may include a deadbolt through-hole 102 that is configured to receive a latch of a deadbolt. In another embodiment, the door jamb reinforcement plate 101 may include a plurality of deadbolt through-holes 102 positioned along the door jamb reinforcement plate 101 such that each through-hole corresponds to deadbolts (and the associated deadbolt latch) that are installed on a door. The deadbolt through-hole 102 may include any suitable shape, such as, for example, a rounded or square slot. The door jamb reinforcement plate 101 further includes a latch through-hole 104 that is configured to receive a latch of a door knob. The latch through-hole 104 may include any suitable shape, such as, for example, a rounded or square slot. The door jamb reinforcement plate 101 further includes one or more through-holes 106 configured to receive a fixation mechanism that affixes the reinforcement plate 101 to a door jamb. The fixation mechanism may include a screw, rivet, nail, bolt, adhesive or any other suitable type of fixation mechanism as is known in the art. In an embodiment, the door jamb reinforcement plate 101 is fastened to the door jamb with an adhesive. In this particular embodiment using an adhesive fixation mechanism, the through-holes 106 may not be required to affix the door jamb reinforcement plate 101 to the door jamb but may be included anyways to further secure the first plate 101 to the door jamb with, for example, screws. The through-holes 106 may include a counter-sink such that a screw head may lie flush to the door jamb reinforcement plate 101 surface when the screw is fully tightened.

In an alternative embodiment, the first plate 101 may include a sleeve or tubular covering extending from one or more of the through-holes for latches of the door knob and/or deadbolts. Such a sleeve may be made out of a similar material as the reinforcement plate and may provide additional surface area for the latch to contact upon application of an impact force to a closed door. The sleeve may extend to an end of a latch when the door is closed or the sleeve may be shorter or longer than the fully extended length of the latch. The sleeve may be welded to the reinforcement plate or fabricated by casting as an integral piece with the reinforcement plate.

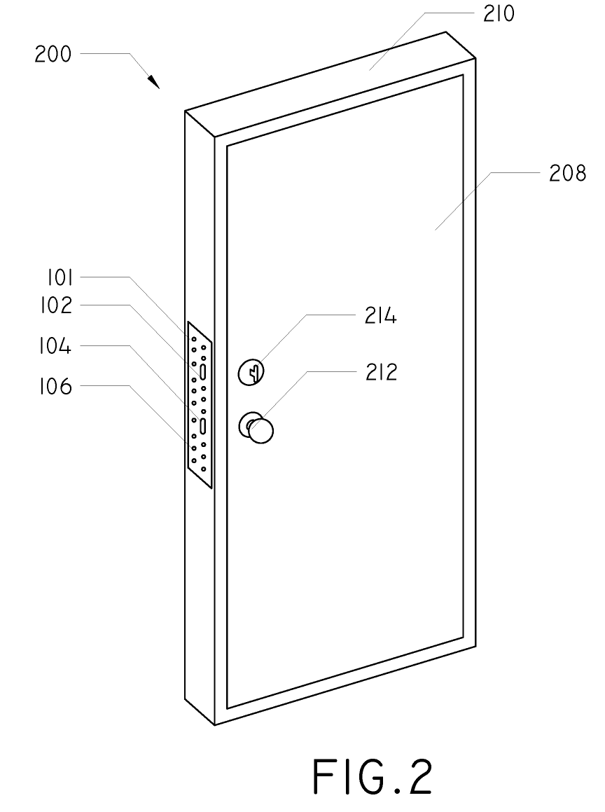

FIG. 2 shows a door jamb reinforcement plate 101 installed on an outer surface of a door jamb 210 within a door frame 200. The door frame 200 includes a door 208 mounted within a door jamb 210 by way of one or more hinges. The door 208 includes a door knob 212 and a deadbolt 214 to provide control of access to a space separated by the door 208 (i.e., by opening and closing the door). The door jamb reinforcement plate 101 is installed on an outer surface of the door jamb 210 that is adjacent to a wall when the door frame 200 is installed within a doorway as will be explained in more detail below.

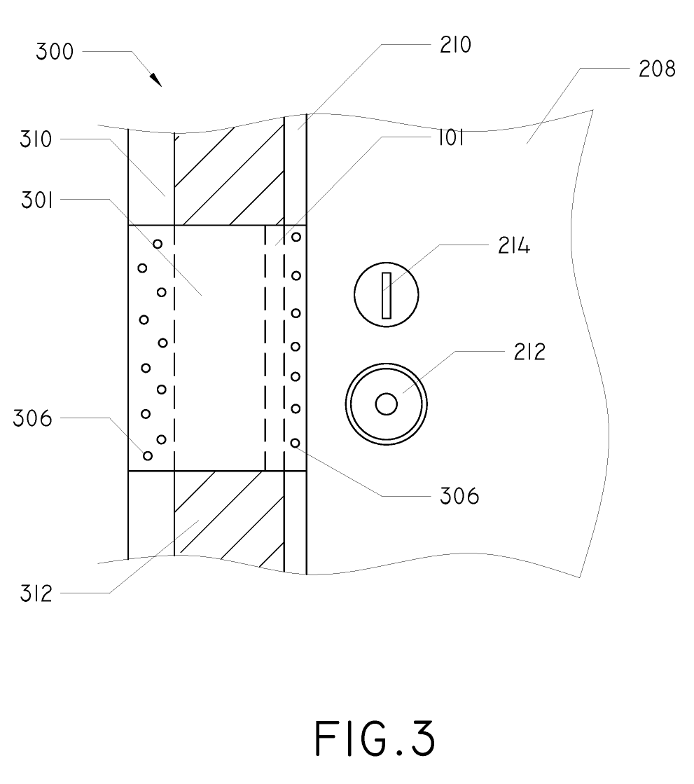

FIG. 3 shows a door jamb reinforcement system 300 including a first door jamb reinforcement plate 101 and a second door jamb reinforcement plate 301 installed perpendicularly to one another. In FIG. 3, the first door jamb reinforcement plate 101 is affixed to an outer surface of a door jamb 210. The door jamb 210 may comprise, for example, one or more 2×4 wood blocks and/or one or more 2×6 wood blocks (or other suitable material) as described above. When the door frame is installed in a doorway, the outer surface of the door jamb 210 may be substantially adjacent and in contact with a wall 312. In an embodiment, the door jamb reinforcement plate 101 may be installed substantially within the wall 312 or on a surface of the wall. In another embodiment, the door jamb reinforcement plate 101 may be installed on an inner surface of the door jamb 210 such that the door jamb reinforcement plate 101 is adjacent to the door 208. A second door jamb reinforcement plate 301 is affixed to a stud 310 within the wall 312 and to the door jamb 210 such that the second door jamb reinforcement plate 301 is substantially perpendicularly to the first door jamb reinforcement plate 101. The stud 310 may comprise, for example, one or more 2×4 wood blocks and/or one or more 2×6 wood blocks (or other suitable material as is known in the art). An end section of the second door jamb reinforcement plate 301 overlaps a side surface of the first door jamb reinforcement plate 101 such that the second door jamb reinforcement plate 301 provides a reaction force against the first door jamb reinforcement plate 101 if a break-in is attempted on a locked door 208 (i.e., when one or more latches are engaged in their respective through-holes in the door jamb 210 and the first door jamb reinforcement plate 101).

The second door jamb reinforcement plate 301 includes a plurality of through-holes 306, where each through-hole is configured to receive a fixation mechanism, such as a screw, bolt, and/or a nail, for example. The through-holes 306 may be substantially similar to the through-holes described above and may be arranged on the second door jamb reinforcement plate 301 in any suitable orientation to affix the second door jamb reinforcement plate 301 to the stud 310, wall 312, door jamb 210, and/or first reinforcement plate 101. In an embodiment, the second door jamb reinforcement plate 301 includes one or more through holes positioned such that fixation mechanisms may affix the second door jamb reinforcement plate 301 to the door jamb 210. Additionally, or optionally, the second door jamb reinforcement plate 301 may include one or more through-holes positioned such that fixation mechanisms may affix the second door jamb reinforcement plate 301 to the first door jamb reinforcement plate 101. In an alternative embodiment, an adhesive may be used to affix the second door jamb reinforcement plate 301 to any of the first door jamb reinforcement plate 101, the wall 312, the stud 310, and/or the door jamb 210. In this embodiment, a portion of the second door jamb reinforcement plate 301 and/or the first door jamb reinforcement plate 101 may be roughened to improve adhesion between the two surfaces by any process as is known in the art, such as, for example, sanding or sandblasting.

The door jamb reinforcement plates 101, 301 may each include two face surfaces separated by respective thicknesses t₁ and t₂ of the respective door jamb reinforcement plate 101, 301. The door jamb reinforcement plates 101, 301 may further include side surfaces substantially perpendicular to the face surfaces. In an embodiment, one of the side surfaces on the first door jamb reinforcement plate 101 may be configured to contact (or be separated by a small distance from) a portion of a face surface of the second door jamb reinforcement plate 301 as described above. The contacting side surface may be treated with a coating to improve the reliability of the door jamb reinforcement plates 101, 301 so that metal-on-metal wear or impact is reduced or eliminated. The coating may be a protective coating such as a metal plating, a polymer, or other suitable coating. In an alternative embodiment, a material may be disposed between the first door jamb reinforcement plate 101 and the second door jamb reinforcement plate 301 to reduce or dampen the impact (or impulse) force transferred from the door to the second door jamb reinforcement plate 301 during an attempted break-in. For example, a polymer or foam material may be disposed between the first door jamb reinforcement plate 101 and the second door jamb reinforcement plate 301 to dampen forces (i.e., act as a dampener) from an attempted break-in that are transferred to the second door jamb reinforcement plate 301.

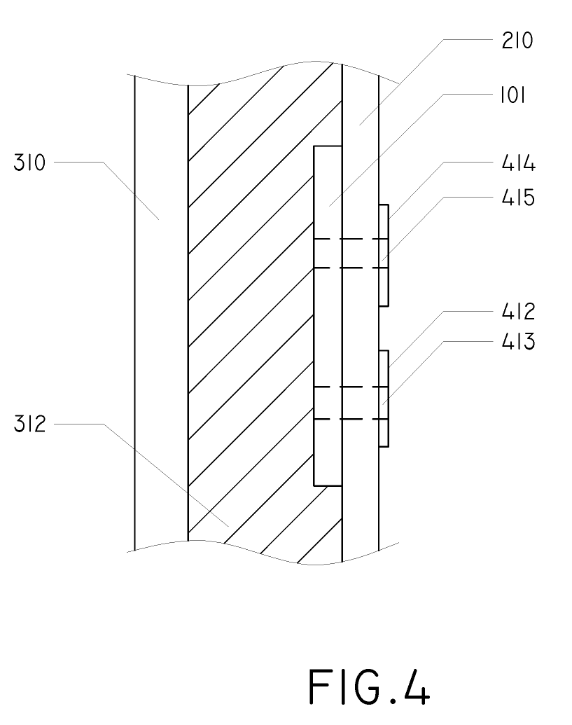

FIG. 4 shows a door jamb reinforcement plate 101 installed on a door jamb 210. As shown in FIG. 4, the door jamb reinforcement plate 101 may be installed on an outer surface of the door jamb 210 such that it is adjacent to a wall 312 (shown in cross-hatching). The wall 312 may be filled with insulation, such as a fiberglass or foam insulation, and may further include one or more studs 310 spaced at a specified distance away from the door jamb 210 or directly in contact with the door jamb 210. One or more strike plates 412, 414 may be installed on an inner surface of the door jamb 210. In particular, strike plate 412 includes a through-hole 413 that is aligned with through-holes in the door jamb 210 and the door jamb reinforcement plate 101 and is configured to receive a latch of a door knob (not shown). Strike plate 414 includes a through-hole 415 that is aligned with through-holes in the door jamb 210 and the door jamb reinforcement plate 101 and is configured to receive a deadbolt latch (not shown). As stated above, the door jamb reinforcement plate 101 may include any number of through-holes to accommodate any suitable number of deadbolts (and the respective deadbolt latches) in addition to a door knob latch.

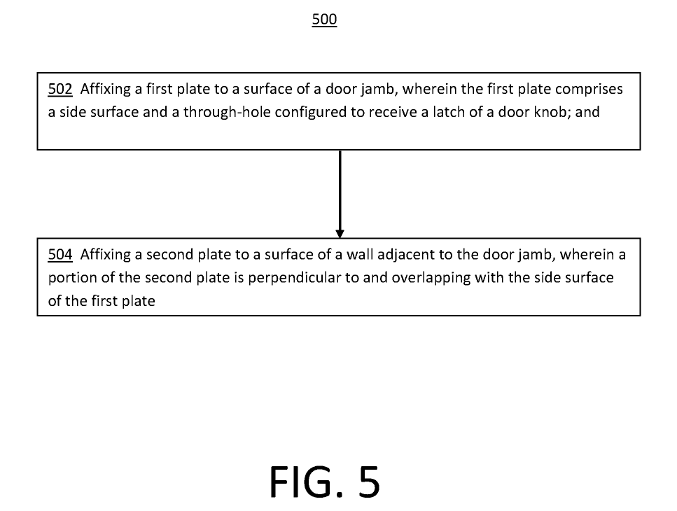

FIG. 5 shows a flow diagram for a method 500 of installing a door jamb reinforcement. At 502, a first plate is affixed to a surface of a door jamb. The first plate includes two face surfaces separated by a thickness t₁, four side surfaces, and a through-hole configured to receive a latch of a door knob. In an embodiment, a face surface of the first plate is affixed to the door jamb. At 504, a second plate is affixed to a surface of a wall. The second plate includes two face surfaces separated by a thickness t₂ and four side surfaces. A portion of an end section of the second plate is substantially perpendicular to and overlapping with one of the side surfaces of the first plate. The second plate is positioned such that the portion of the end section is in contact with the one side surface to provide a reaction force against the first plate upon an impact force on a door transferring force through a door knob latch to the first door jamb reinforcement plate and the second door jamb reinforcement plate.

Variations and modifications will occur to those of skill in the art after reviewing this disclosure. The disclosed features may be implemented, in any combination and subcombination (including multiple dependent combinations and subcombinations), with one or more other features described herein. The various features described or illustrated above, including any components thereof, may be combined or integrated in other systems. Moreover, certain features may be omitted or not implemented. Examples of changes, substitutions, and alterations are ascertainable by one skilled in the art and could be made without departing from the scope of the invention disclosed herein.

What is claimed is:

1. A door jamb reinforcement device comprising:
a first plate comprising a latch through-hole for receiving a latch of a door knob, wherein the first plate is configured to be affixed to a door jamb; and
a second plate perpendicularly disposed to the first plate and in contact with the first plate, wherein the second plate is configured to be affixed to a stud in a wall and the door jamb.

2. The door jamb reinforcement device of claim 1, wherein the first plate further comprises a plurality of fixation through-holes, wherein each fixation through-hole is configured to receive a fixation mechanism.

3. The door jamb reinforcement device of claim 1, wherein the second plate further comprises a plurality of fixation through-holes, wherein each fixation through-hole is configured to receive a fixation mechanism.

4. The door jamb reinforcement device of claim 2, wherein the fixation mechanism comprises screws.

5. The door jamb reinforcement device of claim 1, wherein each of the first plate and the second plate comprises a metal or metal alloy.

6. The door jamb reinforcement device of claim 1, wherein the first plate is affixed to the second plate by a fixation mechanism.

7. The door jamb reinforcement device of claim 1, wherein the first plate includes a dampener on a side surface, said dampener in contact with a face surface of the second plate.

8. A door jamb reinforcement system, the system comprising:
a door frame comprising a door jamb;
a first plate comprising a latch through-hole for receiving a latch of a door knob, wherein the first plate is affixed to the door jamb; and
a second plate perpendicularly disposed to the first plate and in contact with the first plate, wherein the second plate is configured to be affixed to a stud in a wall and the door jamb.

9. The door jamb reinforcement system of claim 8, wherein the first plate is affixed to an outer surface of the door jamb.

10. The door jamb reinforcement system of claim 8, wherein the first plate is affixed to an inner surface of the door jamb.

11. The door jamb reinforcement system of claim 8, said door frame further comprising a door.

12. The door jamb reinforcement system of claim 11, said door further comprising a doorknob and a doorknob latch configured to extend through a first through-hole in the first plate.

13. The door jamb reinforcement system of claim 12, said door further comprising a deadbolt and a deadbolt latch configured to extend through a second through-hole in the first plate.

14. The door jamb reinforcement system of claim 8, wherein the first plate further comprises a plurality of fixation through-holes, wherein each fixation through-hole is configured to receive a fixation mechanism.

15. The door jamb reinforcement system of claim 8, wherein the second plate further comprises a plurality of fixation through-holes, wherein each fixation through-hole is configured to receive a fixation mechanism.

16. The door jamb reinforcement system of claim 8, wherein the first plate is affixed to the second plate by a fixation mechanism.

17. The door jamb reinforcement system of claim 8, wherein each of the first plate and the second plate comprises a metal or metal alloy.

18. A method for reinforcing a door jamb, the method comprising:
affixing a first plate to a surface of a door jamb, wherein the first plate comprises a side surface and a through-hole configured to receive a latch of a door knob; and
affixing a second plate to a surface of a wall adjacent to the door jamb, wherein a portion of the second plate is perpendicular to and overlapping with the side surface of the first plate.

19. The method of claim 18, wherein the portion of the second plate is in contact with the side surface of the first plate to provide a reaction force against the first plate.
